(19) United States
(12) Patent Application Publication
(10) Pub. No.: US 2018/0268348 A1
(43) Pub. Date: Sep. 20, 2018

(54) Automated Receipt of Inbound Parcels and Items

(71) Applicant: Amazon Technologies, Inc., Reno, NV (US)

(72) Inventor: Danny Guan, Seattle, WA (US)

(21) Appl. No.: 13/923,873

(22) Filed: Jun. 21, 2013

(51) Int. Cl. G06Q 10/08

(52) U.S. Cl. CPC G06Q 10/083

(57) ABSTRACT

Systems and methods for improving the efficiency of receiving and registering parcels arriving at a storage facility may identify the parcels and/or any items therein by scanning or reading one or more external markings on the parcels, and route the parcels to designated areas within a multi-dimensional buffer region on a first conveyor or other like apparatus. Within the buffer region, parcels may be positioned and/or rearranged on account of their respective priority levels. When a facility is prepared to receive the items within a parcel, the desired parcel may be retrieved from the buffer region, and the items singulated therefrom. The items may then be transported to an ultimate destination for storage, delivery or further preparation, and one or more attributes of the respective items (including a weight, a dimension or an image) may be gathered from the items while they are en route to the destination.

### BACKGROUND

Typically, when a warehouse or other storage facility receives inbound shipments or parcels of items that have been delivered by a carrier (such as a truck, a rail car, a sea vessel or a cargo plane), the shipments or parcels must be manually removed from the carrier at a dock or other form of loading station, and the source of the shipments or parcels must be identified (i.e., by reading a shipping label or identifying a tracking number within a ledger or other registry). Then, the shipments or parcels must be manually opened, and any associated dunnage must be removed, so that the contents of the shipment (i.e., the items included therein) may be individually identified, inspected and evaluated to determine whether any of the items is damaged, or whether any of the items requires any further preparation. Next, the respective items that are included in the shipments or parcels must be sorted into one or more applicable categories, and placed in one or more appropriate storage areas under suitable conditions, before the items may be registered as having been received at the facility, and ultimately made available for purchase by customers.

Many of the steps that are required to receive and register an inbound shipment or parcel, and to make any items included therein available to customers, such as the acts of unloading the items at the dock station, identifying the source of the shipment or parcel, opening any containers and removing the items therein, typically require a substantial amount of manual labor by human operators, who must also make a significant number of decisions as to where and how the items are to be routed. Likewise, many of the steps that are described above are often redundant or duplicative in nature. Moreover, the process of receiving a shipment and placing the items contained therein into storage is usually completed in its entirety and in series: once the process of unloading and registering an inbound shipment and the items included therein has begun, the process must be finished before the next inbound shipment and the items included therein may be unloaded and registered.

### BRIEF DESCRIPTION OF THE DRAWINGS

FIG. 1 is a block diagram of a system for automatically receiving inbound packages, in accordance with embodiments of the present disclosure.

FIG. 2 is a flow chart of a process for automatically receiving inbound packages, in accordance with embodiments of the present disclosure.

FIG. 3 is a diagram of components of a system for automatically receiving inbound packages, in accordance with embodiments of the present disclosure.

FIGS. 4A, 4B and 4C are diagrams of components of a system for automatically receiving inbound packages, in accordance with embodiments of the present disclosure.

FIG. 5 is a diagram of components of a system for automatically receiving inbound packages, in accordance with embodiments of the present disclosure.

FIG. 6 is a flow diagram of a process for automatically receiving inbound packages, in accordance with embodiments of the present disclosure.

### DETAILED DESCRIPTION

As is set forth in greater detail below, the present disclosure is directed to systems and methods for automating the receipt and registration of inbound shipments or parcels of items at a warehouse or other like storage facility. Specifically, the systems and methods for receiving and registering parcels disclosed herein are directed to identifying and classifying a parcel and/or the items contained therein by scanning or optically recognizing one or more markings on an external surface of a container, conveying the parcel to an assigned portion of a buffer region, and tracking the parcel via video surveillance means. When the storage facility is ready to receive the parcel and the items therein, the parcel may be removed from the assigned portion of the buffer region and manually opened, and the respective items contained therein may be inspected for damages or defects, before various attributes of the items may be gathered by one or more manual or automatic means. Once the attributes have been gathered, the items may be further prepared for delivery to customers as necessary at a preparation station, placed in storage at the warehouse or other like facility, or transported to a delivery station (e.g., an area or device for delivering items) for delivering the items directly to customers.

Accordingly, the systems and methods of the present disclosure provide numerous advantages over the prior art, such as by minimizing the physical interactions with one or more containers included in an inbound shipment or parcel upon their arrival at the warehouse or other storage facility, by automatically recognizing the inbound shipment or parcel based on external markings, by permitting the receipt and registration of items in inbound shipments to be prioritized on any basis, and by automatically routing items to their respective preferred destinations, i.e., to a first station for storage (i.e., a specified location within the warehouse or other storage facility), a second station for delivering the items to customers, or a third station where the items may be further prepared prior to storage or delivery. Moreover, by minimizing the interactions with an inbound shipment or parcel by human operators, the systems and methods of the present disclosure further minimize or remove any subjective decision-making capacity from the human operators, and result in a more objective, standardized processing system.

Presently, when an inbound shipment or parcel consisting of one or more containers arrives at a storage or handling facility in a carrier (i.e., a trailer, a freight car, a container ship or a cargo plane), one or more staff members at the facility must remove the containers from the carrier, and manually identify and/or read a shipping label or tracking number on the containers in order to identify the shipment or parcel, and search for a handwritten purchase order that may be affixed to one or more of the containers. Based on the information included on the label (i.e., the tracking number) and/or in the purchase order, the source of the shipment or parcel may then be identified. Once the source of the shipment or parcel is identified, one or more of the staff members may open the containers, remove any dunnage, and identify and examine the items contained therein, in order to determine whether any of the items require any further preparation upon their arrival at the facility. The containers may then be manually sorted into any applicable categories (e.g., “Requires Further Preparation,” “Includes Large Items” or “Contains Hazardous Materials”), and the shipment or parcel is deemed to have been registered or otherwise checked into the facility.

After the shipment and parcel have been registered or otherwise checked in, each of the items contained therein must again be visually examined so that the items may be made available for sale at an online marketplace. For example, the containers must again be associated with a shipping label or tracking number that accompanied the shipment or parcel, and then opened, so that each of the individual items contained therein may be removed, scanned and/or photographed. Next, product detail pages may be generated for each of the items, which may then be stored in an appropriate location at the facility at which they arrived, or at another facility. Therefore, as is described above, current methods for receiving and registering inbound shipments or parcels require human operators to extensively interact with the arriving shipments or parcels and the items contained therein, and also to make several decisions as to the identification and categorization of the containers and/or the items therein, and the appropriate steps that should be taken in order to process the containers or to prepare the items for storage or delivery to customers.

The systems and methods of the present disclosure are directed to automating and/or streamlining processes for registering and checking in inbound shipments or parcels at storage facilities, and for making one or more items that may be contained therein available for purchase by customers, such as through an online marketplace. Through the use of apparatuses such as optical scanning devices and/or cameras, such systems and methods may automate one or more of the identification, inspection, sorting and allocation of the inbound shipments or parcels, or the items contained therein. According to one embodiment of the present disclosure, one or more of the external surfaces of a container included in an inbound shipment or parcel may be evaluated, scanned and/or photographed to identify any features of the container or markings thereon (e.g., bar codes, “quick response” or “QR” codes, tracking numbers and/or addresses), or to otherwise determine a source of the shipment or parcel, or the contents thereof, which may be associated with such features or markings, or may be identified based on such features or markings. For example, a parcel may be unloaded from a truck at a dock station by a parcel inductor or other staff member and placed onto a conveyor that causes the parcel to travel through an inbound vision area, which preferably includes a tunnel-like apparatus having one or more scanners, cameras or other like machines mounted thereon for reading, capturing and recording the markings on each of the faces (e.g., typically six, for a container that is shaped in the form of a cube or other rectangular solid) of the parcel. The markings may then be correlated with the contents of one or more ledgers or registries to determine the source of the parcel, as well as to identify the contents thereof. Preferably, the markings may be evaluated in real time or in near-real time, and in situ as the parcels travel along the conveyor.

According to yet another embodiment of the present disclosure, containers that are included in an inbound shipment or parcel may be automatically identified asynchronously. For example, as is discussed above, when a container is unloaded from a carrier at a dock station, any external markings on the container may be photographed, and the photographs of the markings may be transmitted to an external site for analysis in order to identify the shipment, the parcel, the container and/or the items included therein. Therefore, where the markings on a container are not immediately identifiable in situ through scanning or other optical recognition means, photographs of such markings may be captured, and the container may be placed in a storage area until the markings have been interpreted.

According to another embodiment of the present disclosure, containers included in an inbound shipment or parcel arriving at a warehouse or other storage facility may be tracked via video surveillance from their arrival at the facility and until the containers are opened and the items therein are examined, registered or checked in at the facility. In such a manner, video evidence of the status of the containers and the items therein may be obtained and utilized to confirm the safekeeping of the containers and/or the items within the facility, and to defend the facility against any claims for damages. For example, the systems and methods disclosed herein may employ video cameras or other recording devices from the point of arrival of the parcel to a final destination within the facility, and may record each of the status of the parcel, and the actions taken with regard to the registration and processing of the parcel, throughout the process. Additionally, by monitoring the shipment or parcel with video surveillance, the shipment's or parcel's actual location within the system may always be determined, and neither the shipment or parcel nor the items contained therein may ever be lost.

According to another embodiment of the present disclosure, the one or more containers included in an inbound shipment or parcel may be placed in a designated location within one or more versatile buffer regions, such that the order in which the containers are processed (e.g., unpacking the containers and registering the items therein) may be prioritized. A buffer region may include flexible storage areas in multiple dimensions (i.e., in a two-dimensional or a three-dimensional space) and may permit a facility to process containers in the most efficient manner, rather than being required to address each container in series (i.e., where containers are received and registered in a one-dimensional path). For example, where a parcel is identified as containing items of a high priority level or ranking with respect to one or more other items, or as originating from a source that is known to provide items of a high priority level or ranking, the parcel may be placed in a forward area or preferred portion of a buffer region within a storage facility, and may bypass other parcels for processing by the storage facility at the next available opportunity. Conversely, where the parcel is identified as including items that are not particularly essential at the time of the parcel's arrival, the parcel may be placed in a holding area or temporary storage portion of the buffer region where the parcel may be bypassed by other parcels containing items of higher priority levels or rankings, and until the storage facility has a sufficient capacity or demand for processing the parcel.

Moreover, because such a buffer region may feature an expanded, multi-dimensional storage capacity, a carrier (e.g., a truck, a trailer, a freight car, a container ship or a cargo airplane) may be unloaded at a dock station more quickly than if each of the containers carried thereon was required to be processed immediately upon unloading. Moreover, where, as is discussed above, the source or the contents of the parcel may not be immediately determined by scanning markings on external surfaces thereof, and photographs of the markings are captured for further analysis and identification, the parcel may be placed in one or more of the flexible storage areas within the buffer region until the source or the contents of the parcels may be identified.

Those of ordinary skill in the pertinent art will recognize that priority level of a parcel, or an item contained in such a parcel, may be defined on any basis, such as a time or date at which the parcel departed from a source or is received by one or more of the systems and methods disclosed herein, or a time or date at which the parcel or the item is expected to arrive at a destination (e.g., a customer or other final location). The priority level of the parcel or the item may also be determined based on a time or date at which the contents thereof may be expected to spoil, expire or otherwise be rendered without value (e.g., an expiration date for perishable goods or a holiday for holiday-themed item), or on any restrictions or conditions on the distribution of the item (e.g., time-limited restrictions such as alcoholic beverages or products containing tobacco). The priority level of the parcel or the item may further be determined based on an inventory level of the item or an attribute of the item (e.g., frozen foods may be assigned a higher level of priority than a canned non-perishable good, while a bathing suit may be assigned a higher level of priority in the spring or summer months than a ski parka, and vice versa in the fall and winter). Additionally, a priority level of the parcel may be determined according to an amount of storage capacity that is available in the vicinity of one or more of the systems and methods disclosed herein, or at an ultimate destination for the item.

Those of ordinary skill in the pertinent art would also recognize that a priority level of a parcel or an item may be determined with respect to one or more other parcels or items on any basis. For example, a priority level of a parcel or an item may be determined based on a date on which parcels are received, such that newly received parcels or items fall below previously received parcels in terms of priority. Another priority level of a parcel or an item may be determined based on an estimated departure time of the parcel or the item, such that parcels or items that are expected to depart sooner have higher priority levels than other parcels or items. Still other priority levels of parcels or items may be determined based on expiration dates of the parcels or the items, such that parcels or items that are expected to spoil, expire or otherwise be rendered without value sooner may be deemed to have higher priorities than other parcels or items. Furthermore, a priority level of a parcel or an item may be determined based on the attributes of either the parcels or the items. For example, parcels that contain items from a specific location or include a specific type of item (e.g., Copper River salmon or Hawaiian pineapples) may be deemed to have a higher priority than parcels containing items from different locations or including other types of items (e.g., salmon from locations other than the Copper River, or Hawaiian shirts).

Those of ordinary skill in the pertinent art would further recognize that any relevant factor relating to an item may be utilized in determining one or more levels of priority for the item or a ranking of the item with respect to one or more other items in accordance with the systems and methods of the present disclosure. Likewise, those of ordinary skill in the pertinent art would also recognize that a priority level for an item or a ranking of the item may be defined based on multiple factors, and that a priority level may take any qualitative or quantitative form, including words or terms (e.g., “high,” “medium” or “low”; or “red,” “yellow” or “green”) as well as numerical scores or figures defined according to one or more scales or bases (e.g., “95%” or “four out of five stars”).

According to yet another embodiment of the present disclosure, the processing of the one or more containers included in an inbound shipment or parcel may be streamlined, such that a particular container within a shipment or parcel is handled on as few as two occasions: once when the container is unloaded from the carrier at a dock station by a parcel inductor or other staff member, and again when the container is opened for inspection at the buffer region by a singulation receiver or other staff member. Specifically, once a parcel is placed upon a conveyor or other transporting apparatus, the parcel need not be touched until the parcel is extracted from the buffer region and the items contained therein are removed, or singulated, by one or more receivers such that the items may be internally inspected.

According to still another embodiment of the present disclosure, attributes of an inbound shipment or parcel, or of any of the items within the inbound shipment or parcel, may be automatically captured as the items are transferred on a conveyor or other like means. For example, the items may be individually weighed on a scale or other measuring apparatus, and other dimensions of the items may be captured through optical recording or measuring means (i.e., cameras adapted to measure lengths, widths or depths of items and/or containers on a moving conveyor). Finally, according to yet another embodiment of the present disclosure, items may be automatically routed from one or more aspects within a registration system to an ultimate destination, i.e., to a facility or station for further preparation, to a facility or station for storing the items, or to a facility or station for delivering the items to a customer, through one or more automatic conveying means.

Moreover, according to yet another embodiment of the present disclosure, one or more machine learning algorithms, models, functions or techniques may be utilized to predict an identity of one or more items in a container based on one or more attributes of the container or the items (e.g., features or external markings). Once the container is opened, and the identities of the items contained therein are confirmed, the confirmed identities of the items may be used to train the one or more learning algorithms, models, functions or techniques in the future with feedback in the form of the confirmed identities of the items. For example, where an item is preliminarily identified according to one or more such algorithms, models, functions or techniques based on an external marking (e.g., a bar code, tracking number or address) of a container, once the identity of the item is confirmed, such algorithms, models, functions or techniques may be trained by a comparison of the predicted identity of the item to the confirmed identity of the item. By training such algorithms, models, functions or techniques using historical, confirmed data, the predictions of the identities of items in the future may be further refined.

Those of ordinary skill in the pertinent arts would recognize that any form of learning algorithm, model, function or technique may be utilized to identify an item based on attributes of the container or the item contained therein in accordance with the present disclosure. For example, any form of logical or mathematical model, and one or more such models, may be employed to predict an identity of an item based on any available information regarding a container that includes such an item. Such models may be trained using datasets that comprise attributes of containers and/or items, and the confirmed identities of items, by systematically generating or defining one or more functions or equations corresponding to relationships between such attributes and such confirmed identities. Any other algorithms or techniques may be used in predicting an identity of an item based on attributes of a container, including but not limited to nearest neighbor methods or analyses, artificial neural networks, factorization methods or techniques, K-means clustering analyses or techniques, similarity measures such as log likelihood similarities or cosine similarities (e.g., for measuring the similarities or relationships between attributes of containers and identities of items), Bayesian classifiers, singular value decomposition methods, latent Dirichlet allocations or latent semantic analyses, in accordance with the systems and methods of the present disclosure.

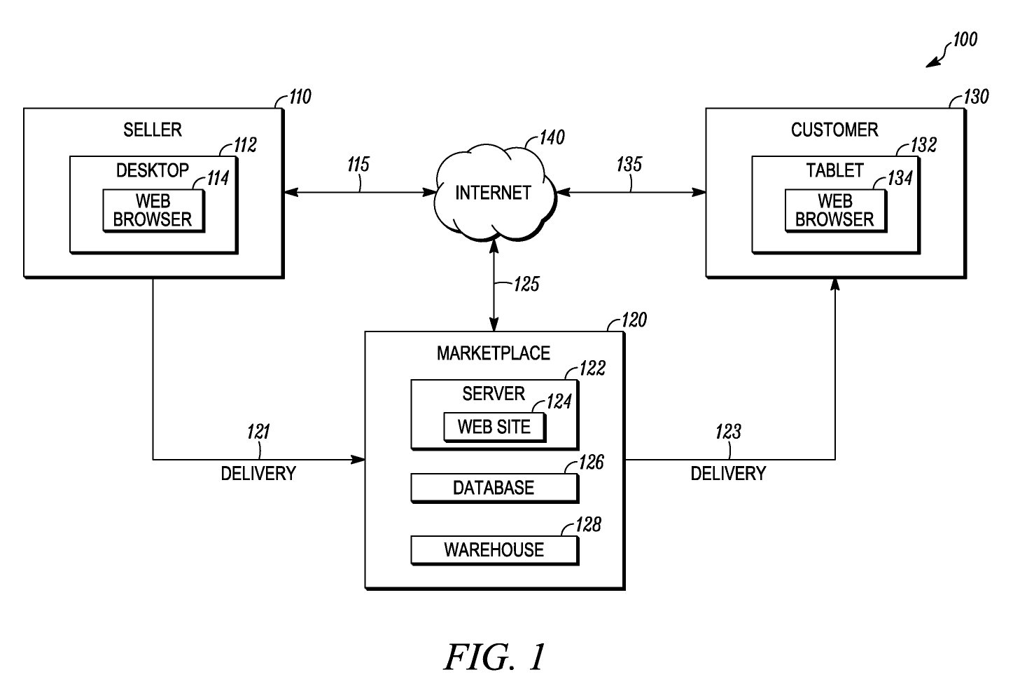

Referring to FIG. 1, a block diagram of one system 100 for automatically receiving inbound packages is shown. As is shown in FIG. 1, the system 100 includes a seller 110, a marketplace 120 and a customer 130 that are connected to one another across a network 140, such as the Internet. The seller 110 can be any entity or individual that wishes to make one or more items available to customers, such as the customer 130, at the marketplace 120. The seller 110 may operate one or more order processing and/or communication systems which may be implemented through one or more computing machines that may be connected to the Internet 140, in order to transmit information in the form of digital or analog data regarding one or more items to be made available at the marketplace 120, or for any other purpose. For example, the seller 110 may communicate with the marketplace 120 through one or more interfaces provided by a web browser 114 operating on a desktop computer 112 that is connected to the Internet 140, as is indicated by line 115.

The seller 110 may deliver one or more items to the marketplace 120 and/or one or more designated storage facilities maintained by the marketplace 120, such as a warehouse 128, as is indicated by line 121. Additionally, the seller 110 may receive one or more items from a manufacturer (not shown), a vendor (not shown) or another seller (not shown), and may deliver one or more of such items to the marketplace 120 for fulfillment and distribution to customers, such as the customer 130. Furthermore, the seller 110 may perform multiple functions, i.e., the seller 130 may also be a manufacturer and/or a vendor of one or more items, and may also offer items for purchase by customers at outlets or venues (not shown) other than the marketplace 120.

The marketplace 120 may be any entity or individual that wishes to make items from a variety of sources available for download, purchase, rent, lease or borrowing by customers through the use of at least one web site or web page maintained using a networked computer infrastructure, including one or more physical computer servers 122 hosting a web site 124, as well as one or more databases 126. The marketplace 120 may also have physical or virtual access to one or more storage facilities, such as the warehouse 128. The web site 124 may be implemented using the one or more servers 122, which connect or otherwise communicate with the one or more databases 126, as well as the network 140, as indicated by line 125, through the sending and receiving of digital data. In addition, items that are made available at the marketplace 120 or ordered therefrom by customers may be made by or obtained from one or more third party sources, such as the seller 110, or from any other source (not shown). Moreover, the marketplace 120 itself may be a seller, a vendor or a manufacturer.

The customer 130 may be any entities or individuals that wish to download, purchase, rent, lease, borrow or otherwise obtain items (which may include goods, products, services or information of any type or form) from the marketplace 120. The customer 130 may utilize one or more computing devices, such as a tablet computer 132, or any other like machine that may operate or access one or more software applications, such as a web browser 134, and may be connected to or otherwise communicate with the seller 110 or the marketplace 120 through the network 140, as indicated by 135, by the transmission and receipt of digital data. Moreover, the customer 130 may also receive deliveries or shipments of one or items from the marketplace 120, as indicated by line 123.

Those of skill in the pertinent art will recognize that the seller 110, the marketplace 120 and the customer 130 may use a keyboard, keypad, mouse, stylus, touch screen, or other device (not shown) or method for interacting with the desktop computer 112 and/or the web browser 114; the marketplace 120, the server 122 and/or the web site 124; the tablet computer 132 and/or the web browser 134, or to “select” an item, link, node, hub or any other aspect of the present disclosure.

The computers, servers, devices and the like described herein have the necessary electronics, software, memory, storage, databases, firmware, logic/state machines, microprocessors, communication links, displays or other visual or audio user interfaces, printing devices, and any other input/output interfaces to perform the functions described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” an item, link, node, hub or any other aspect of the present disclosure.

Process steps described herein as being performed by a “seller,” a “marketplace” or a “customer” may be automated steps performed by their respective computer systems, or implemented within software modules (or computer programs) executed by one or more general purpose computers. Moreover, process steps described as being performed by a “seller,” a “marketplace” or a “customer” may be typically performed by a human operator via the desktop computer 112, the server 122 and/or the tablet computer 132, but could, alternatively, be performed by an automated agent.

The seller 110, the marketplace 120 and/or the customer 130 may use any web-enabled or Internet applications or features, such as the web browsers 114, 134 or the web site 124, or any other client-server applications or features including electronic mail (or E-mail), or other messaging techniques, to connect to the Internet 140 or to communicate with one another, such as short or multimedia messaging service (SMS or MMS) text messages. In addition, the desktop computer 112, the server 122 or the tablet computer 132 may include any of a number of computing devices that are capable of communicating over the network, including but not limited to set-top boxes, personal digital assistants, mobile phones including “smartphones,” digital media players, web pads, tablet computers, laptop computers, desktop computers, electronic book readers, and the like. The protocols and components for providing communication between the desktop computers 112, the server 122 and the tablet computer 132 are well known to those skilled in the art of computer communications and thus, need not be described in more detail herein.

The data and/or computer executable instructions, programs, firmware, software and the like (also referred to herein as “computer executable” components) described herein may be stored on a computer-readable medium that is within or accessible by the desktop computer 112, the server 122 and/or the tablet computer 132, and having sequences of instructions which, when executed by a processor (such as a central processing unit, or CPU), cause the processor to perform all or a portion of the functions and/or methods described herein. Such computer executable instructions, programs, software and the like may be loaded into the memory of the desktop computer 112, the server 122 and/or the tablet computer 132 using a drive mechanism associated with the computer readable medium, such as a floppy drive, CD-ROM drive, DVD-ROM drive, network interface, or the like, or via external connections.

Some embodiments of the systems and methods of the present disclosure may also be provided as a computer executable program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), erasable programmable read-only memories (EPROMs), electrically erasable programmable read-only memories (EEPROMs), flash memory, magnetic or optical cards, solid-state memory devices, or other types of media/machine-readable medium that may be suitable for storing electronic instructions. Further, embodiments may also be provided as a computer executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

For the purposes of illustration, some of the systems and methods disclosed herein may be referenced primarily in the context of systems for receiving and registering inbound shipments or parcels including one or more items at a warehouse or other storage facility, and maintaining a web site that may be accessed by various sellers or other sources who wish to make one or more items available to customers, and also by one or more customers who wish to download, purchase, rent, lease or borrow one or more items over the Internet, such as the web site 124 maintained by the marketplace 120, as is shown in FIG. 1. As will be recognized by those of skill in the art, however, the systems and methods disclosed herein may also be used in many other situations, and their utility is not limited to any of the preferred embodiments described herein.

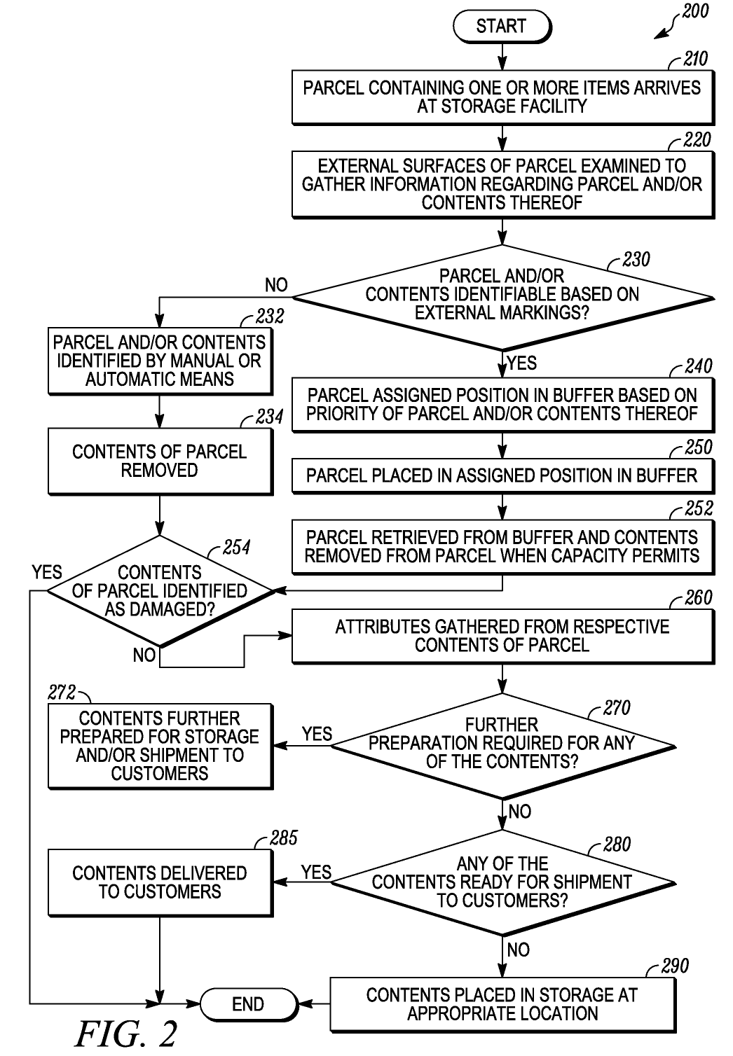

As is discussed above, where a shipment or parcel arrives at a warehouse or other storage facility, including such a facility maintained or utilized by an online marketplace, the systems and methods of the present disclosure may be utilize to automate or streamline the receipt and registration of items included in an inbound shipment or parcel upon the arrival of the shipment or the parcel at the facility. Referring to FIG. 2, a flow chart 200 representing one embodiment of a process for automatically receiving inbound packages in accordance with embodiments of the present disclosure is shown. At step 210, a parcel containing one or more items arrives at a storage facility (e.g., a warehouse or other like building or structure). The parcel may arrive via any known transportation means, including ground, sea or air transit.

At step 220, the external surfaces of the parcel may be examined to gather information regarding the parcel and/or the contents thereof. For example, the external surfaces of the parcel may include a bar code, a QR code or written text or numbers that may be scanned or “read” using mounted scanners and/or cameras adapted to optically recognize text or other markings on the parcel. The parcel may be loaded onto a conveyor or like transporting means at a dock station within the facility by a parcel inductor or other staff member, and automatically transported through an inbound vision apparatus or tunnel having one or more such scanners and/or cameras, such that each of the faces or aspects of the parcel may be scanned and/or photographed.

At step 230, it is determined whether the parcel and/or the contents thereof may be automatically identified based on any markings on the external surfaces of the parcel (e.g., to a sufficiently high degree of confidence). If the parcel and/or the contents thereof may be identified, then the process advances to step 240, where the parcel is assigned a position in a multi-dimensional buffer based on a priority level of the parcel and/or the contents thereof, and to step 250, where the parcel is placed in the assigned position within the buffer. For example, if the parcel is identified as containing one or more particularly valuable or time-critical items, the parcel may be allocated to a preferential area within the buffer through the use of a conveyor or one or more like systems for transporting parcels, such that the parcel may be quickly and efficiently recalled for processing at the next available opportunity. Where the parcel is identified as containing items that are not essential at the time of the parcel's arrival, the parcel may be allocated to a less-advantageous portion of the buffer buy a conveyor or other like system, and may be bypassed for processing by other parcels that may be more important at the time of their arrival. The areas of the buffer may be identified with respect to their location within two-dimensional (i.e., the length and the width of the buffer) or three-dimensional (i.e., the length, the width or the height of the buffer), as necessary, and the assignment of positions for parcels may be prioritized based on any type of information or factor regarding the source of the items, the destination of the items, or the items themselves, including a model number, a serial number, or any other aspect or identifying feature.

At step 252, the parcel may be retrieved from the buffer, and the contents of the parcel (i.e., one or more items contained within the parcel) may be removed, or singulated, when the processing capacity of the facility permits. For example, when the facility is ready to process the parcel, the parcel may be extracted from the region of the buffer where the parcel has been allocated, and the items within the parcel may be removed for inspection and analysis by one or more singulation receivers before being placed on a subsequent conveyor or other like machine for automatically transporting the items to their respective destinations which may be located elsewhere within the facility.

At step 254, the contents of the parcel may be inspected for damage. If the contents of the parcel are damaged, the process ends. If the contents of the parcel are not damaged, then the process advances to step 260, where one or more attributes of each of the singulated contents may be gathered by manual or automatic means, in order to further discern any additional information or data regarding the respective items. Preferably, the attributes may be gathered from each of the individual items as they are transported on a conveyor or other like machine across a scale or other means for determining a mass or weight of an item, or through or past a battery of cameras or other recording devices for capturing one or more perspectives or dimensions of the items, as well as one or more photographs of the items. Gathering such attributes as the items are being transported on a conveyor or other like device further enhances the efficiency of the systems and methods disclosed herein, as the attributes may be obtained without any human interaction with the respective parcels, and while the items are en route to their respective destinations. Moreover, once the attributes and/or other information have been gathered, such attributes and information may be utilized to record the arrival of the individual items at the facility, to generate one or more product detail pages for the item, or for any other purpose.

At step 270, it may be determined whether any of the singulated contents requires further preparation, such as packaging the items in one or more additional containers, or with additional dunnage. For example, where a parcel includes a large number of items that are occasionally distributed in groups of smaller numbers of items (i.e., where an inbound shipment or parcel includes three hundred golf balls, which are typically sold in boxes of three golf balls apiece), the items may require repackaging into boxes of three golf balls apiece. Where a parcel includes a number of digital versatile discs (or DVD) of movies in a three-movie series, some of the DVDs may be packaged for individual distribution, and some of the DVDs may be sold collectively in a box set including one of each of the movies in the series. If any of the items require further preparation, the process advances to step 272, where the contents may be further prepared for storage and/or delivery to customers, as required, before returning to step 260, where one or more of the attributes of the further prepared (e.g., repackaged) items may be gathered.

If the items do not require further preparation, then the process advances to step 280, where it is determined whether any of the contents is ready for immediate delivery to customers. If the contents are ready for delivery, then the process advances to step 285, where the contents are delivered to the customers who ordered them, and the process ends. If the contents are not ready for delivery, then the process advances to step 290, where the contents may be placed in storage in an appropriate location, and the process ends. For example, when an online marketplace receives an order for one of two items in the parcel that is stored within a buffer region, the parcel may be retrieved from the buffer region and unpacked. Then, the item for which the online marketplace has received an order may be transported to the customer that placed the order, while the item for which no order has been received may be placed in storage.

If the parcel and/or the contents thereof were not identifiable based on any external markings on the parcel at step 230, then the process may advance to step 232, where the parcel and/or the contents may be identified by manual or automatic means, i.e., by having a human operator, such as a singulation receiver, examine or open the parcel and physically handle the contents thereof in order to identify them. Then, the process may advance to step 234, where the contents of the parcel may be removed, and to step 254, where the contents of the parcel may be inspected for damage. If the contents of the parcel are damaged, then the process ends. If the contents of the parcel are not damaged, then the process advances to step 260 where, as is described above, one or more attributes of the singulated items may be gathered by manual or automatic means.

Accordingly, the systems and methods of the present disclosure may be utilized to automate and/or streamline one or more processes for receiving and registering inbound shipments or parcels, and for making one or more items included therein available to customers, by requiring a particular container within a shipment or parcel to be handled just twice: first, by one or more parcel inductors, when the container is unloaded from a carrier and placed on a first conveyor at the dock station to transport the container through an inbound vision station to a buffer region, and second, when the container is extracted from the buffer region and opened, and the items therein are singulated and inspected by one or more singulation receivers, before being placed on a second conveyor to transport the items to their ultimate destinations within the facility, i.e., a location where the items may be stored, a location where the items may be delivered to customers, or a location where the items may be further prepared for storage or delivery.

Although the process represented in flow chart 200 of FIG. 2 contemplates identifying a parcel or the contents thereof by manual or automatic means where the parcel cannot be identified based on one or more external markings thereon, the systems and the methods of the present disclosure are not so limited. As is discussed above, where a parcel may not be identified by scanning or otherwise reading a bar code, a label, an address, a tracking identifier or another identifier on an external surface of the parcel, or by identifying at least one feature of the parcel (e.g., a mass or a weight of the parcel), the parcel may be allocated to an area within the buffer until the parcel and/or the contents therein are identified. For example, if the parcel may not be identified in real time or in near-real time by the system based on a scanning or reading of an identifier on the outside of the parcel, one or more photographs of the identifier may be taken, and the parcel may be stored in an assigned position within the buffer. Then, the photographs may be transmitted to an external source that may specialize in extracting text, numbers, bar codes or other information from photographs for interpretation. If the identifier may be interpreted from the photographs, and the parcel may be identified based on the identifier, the parcel may be placed in another location within the buffer or processed by the system, as required. If the identifier may not be interpreted, or if the parcel may not be identified based on the identifier, the parcel may be further evaluated by other means, i.e., by one or more singulation receivers or other human operators, to identify the parcel and/or the contents thereof.

Moreover, as is discussed above, machine learning algorithms, models, functions or techniques may be utilized to predict an identity of one or more items in a container based on one or more attributes of the container or the items. For example, where the identities of the contents of a parcel are predicted based on one or more attributes of the parcel, such as the information gathered from the external surfaces of the parcel at step 220 of the process shown in the flow chart 200 of FIG. 2, the identities of the contents may be confirmed when the item is ultimately opened, such as following the retrieval of the parcel from the buffer at step 252. Once the identities of the contents are confirmed, the confirmed identities may be compared to the predicted identities, and the algorithms, models, functions or techniques for predicting the identities of such contents may be trained accordingly. Conversely, where an identity of an item may not be predicted based on the attributes of a parcel containing the item, then upon an identification of the parcel and/or the item, such as following the manual or automatic evaluation of the parcel or contents at step 232, the confirmed identity of the item may be correlated with the attributes of the parcel, and the algorithms, models, functions or techniques for predicting the identities of such contents may also be trained accordingly.

In such a manner, the systems and methods of the present disclosure may further refine their predictive accuracy, and enable more precise predictions of identities of items in the future. By training predictive algorithms, models, functions or techniques with feedback in the form of confirmed results of their respective predictions, the systems and methods disclosed herein may better determine, for example, whether a ten-pound rectangular solid package from a grocer identified by a bar code contains frozen beef or canned vegetables, or whether a slender box from a sporting goods manufacturer that has a mass of thirty-six ounces contains a baseball bat or a golf driver. Enhancing the predictive capacity of such systems and methods ensures that parcels may be placed within more appropriate areas or regions of a buffer or other storage facility.

As is also discussed above, some embodiments of the systems and methods disclosed herein, such as the process represented in flow chart 200 of FIG. 2, may provide further advantages over prior art systems and methods for receiving and registering inbound shipments or parcels, based on the presence of one or more cameras and/or other video recording equipment that may be utilized during the scanning of the external markings on the parcel and the gathering of attributes from the singulated items. Such equipment, or other scanners, cameras or like equipment, may be further utilized to provide video surveillance of parcels and/or items throughout the reception and registration processes

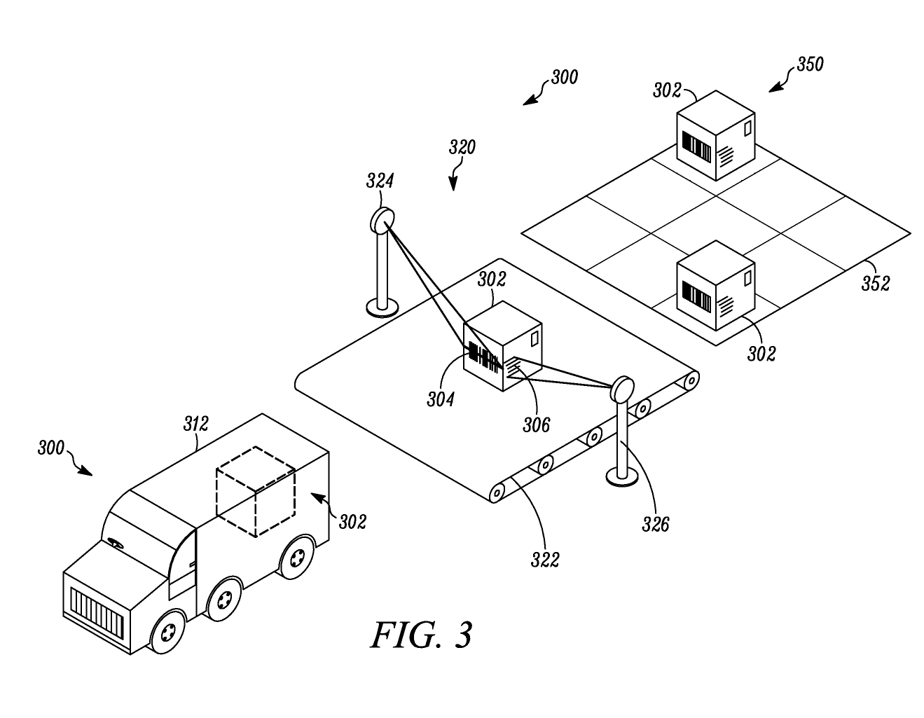

The systems and methods of the present disclosure may incorporate a variety of components for receiving, identifying, registering, storing and retrieving inbound shipments or parcels, and for examining, preparing, storing and delivering items contained within such shipments or parcels, in one or more arrangements. Referring to FIG. 3, an arrangement 300 of components of a system for automatically receiving inbound packages in accordance with one embodiment of the present disclosure is shown. The arrangement 300 includes an inbound delivery station (or dock station) 310, an inbound vision station 320 and a buffer region 350.

At the inbound delivery station 310, a truck 312 arrives with a parcel 302 including one or more items. The parcel 302 in the truck 312 may be placed on a conveyor 322 by one or more parcel inductors or other staff members. At the inbound vision station 320, a parcel 302 having a bar code 304 and an address 306 stamped thereon is transported on the conveyor 322 between a bar code reader 324 and an optical recognition scanner 326. The bar code reader 324 is aligned to identify and capture any type of representation of data expressed in one-dimension or two-dimension patterns, such as in parallel lines (i.e., a traditional bar code) or in a grid (i.e., a QR code), printed on or affixed to an external surface of a parcel. The optical recognition scanner 326 is aligned to identify and convert text or numbers that may be printed or written on an external surface of a parcel into machine-encoded text or data.

Therefore, according to one embodiment of the present disclosure, when a parcel 302 having a bar code 304 and/or an address 306 printed on one or more of its external surfaces is transported from an inbound delivery station 310 to a buffer region 350 on a transporting apparatus, such as a conveyor 322, the surfaces of the parcel 302 may be evaluated using one or more scanning or reading devices, such as the bar code reader 324 and the optical recognition scanner 326. Any information that may be derived from the bar code 304 and/or the address 306 may be utilized to identify the parcel 302, a source of the parcel 302, or one or more items contained in the parcel 302.

Although the inbound vision station 320 shown in FIG. 3 includes just one bar code reader 324 and just one optical recognition scanner 326, any number of scanning or reading devices may be utilized to evaluate the external surfaces of parcels, in accordance with the present disclosure. Preferably, an inbound vision station 320 may include readers and/or scanners for evaluating each of the surfaces of a parcel, i.e., each of the six surfaces of a cube-shaped or rectangular solid-shaped container, such as the parcels 302 shown in FIG. 3. Moreover, the readers and/or scanners may be mounted within a tunnel-type structure, and incoming parcels, such as the parcel 302 on the conveyor 322 shown in FIG. 3, may travel through the tunnel-type structure as the one or more markings on the external surfaces of the parcels are read or scanned. Those of ordinary skill in the art would also understand that the features of the bar code reader 324 and the optical recognition scanner 326, or like machines, could be combined into one or more single, composite scanning and reading devices.

The buffer region 350 shown in FIG. 3 is a two-dimensional storage space defined by a grid 352 that includes multiple subregions, each of which may accommodate a parcel, including the two parcels 302 shown in FIG. 3. Parcels arriving from the inbound vision station 320 may be delivered to the buffer region 350 for temporary storage, and allocated to one or more of the subregions defined by the grid 352. The placement of parcels within the buffer region 350 may be determined based on the demand for items that may be contained in the particular parcels, the labor or staffing levels that may be available to process such parcels, or any other reason, and may enable the parcels or items having higher levels of priority or more highly ranked items to be accessed by the facility for processing with minimal difficulty, while placing parcels or items having lower levels of priority or lower-ranked items in less essential or time-critical regions on a short-term or long-term basis.

By providing a flexible storage space having multiple dimensions, instead of a substantially linear conduit or channel defined by a single dimension, the systems and methods of the present disclosure may prioritize the registration of parcels, such as the two parcels 302 shown in the grid 352 of the buffer region 352, based on the demands for the items therein, or the capacities of the system. For example, the arrangement of the two parcels 302 within the grid 352 shown in FIG. 3 permits an incoming parcel, such as the parcel 302 on the conveyor 322, to transit through the buffer region 350 and to be processed before either of the two parcels 302 within the grid 352. The arrangement of the two parcels 302 within the grid 352 shown in FIG. 3 enables an incoming parcel to be stored in one or more of the empty subregions within the grid 352. Finally, the arrangement of the two parcels 302 within the grid 352 shown in FIG. 3 also enables the various parcels 302, or subsequently arriving parcels, to be moved or interchanged within the respective subregions of the grid 352, as may be required based on the demands and priorities of the system.

Moreover, the temporary multi-dimensional storage space of the buffer region 350 permits a carrier, such as the truck 312, to fully discharge its parcels at a dock station of a warehouse or other storage facility without requiring staff members, such as singulation receivers, to open and examine the contents of the parcels, and to register the items included therein immediately upon the parcels' arrival. Such flexibility is particularly valuable where a parcel may not be recognized immediately upon a scanning or reading of its external surfaces, such as in the inbound video station 320, and where the parcel is placed in the buffer region 350 for temporary storage until the parcel may be identified or classified.

The buffer regions of the present disclosure, such as the buffer region 350 of FIG. 3, may take any multi-dimensional form, and may include any number of subregions. For example, a buffer region may have two dimensions, such as the buffer region 350 of FIG. 3, which includes nine subregions in a three-by-three (3×3) grid, or three dimensions, i.e., with subregions arranged in the vertical space, in addition to the horizontal space. Furthermore, each of the subregions within a buffer region may have any size or shape, depending on the particular application of the systems and methods of the present disclosure. In a preferred embodiment, each of the subregions within a two-dimensional buffer region are equally sized, thereby providing maximum flexibility for transferring parcels within the buffer region, and may accommodate parcels having a footprint of up to three feet by three feet. Additionally, the number of subregions that may be included within a buffer region is a function of the design rate for the receipt of inbound parcels (i.e., the maximum rate at which parcels may arrive in carriers, such as the truck 312 of FIG. 3, at a warehouse or other storage facility in accordance with the systems and methods of the present disclosure) and the removal rate of parcels from the buffer region (i.e., the rate at which items included in parcels within the buffer region are singulated and registered).

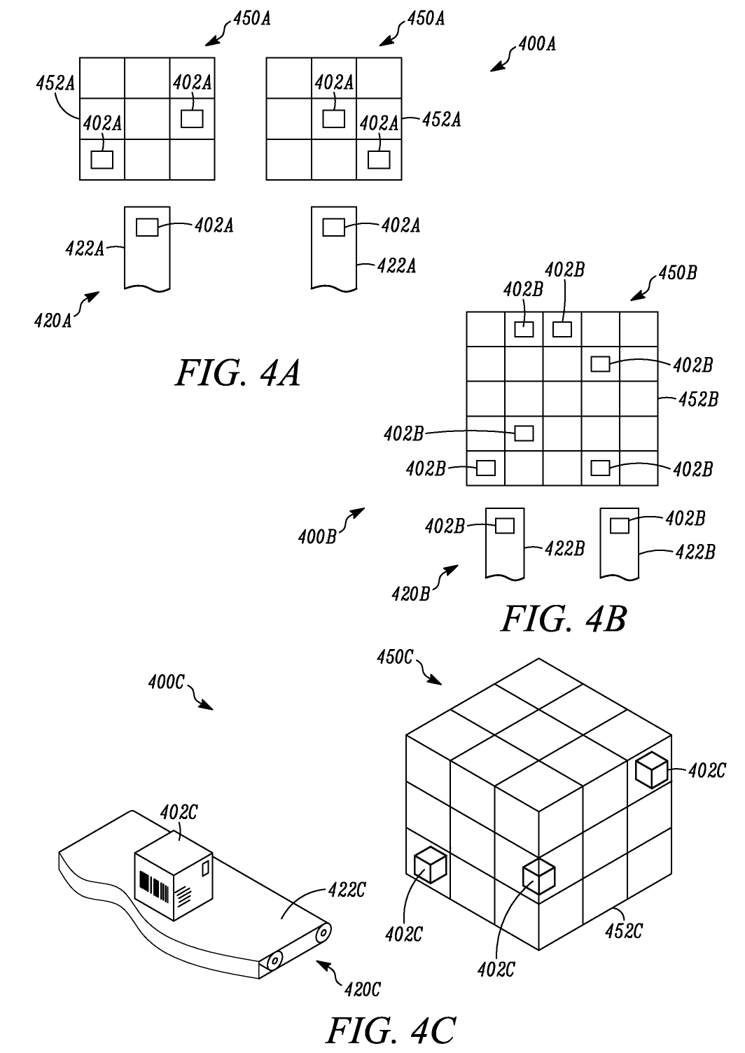

Warehouses or storage facilities operating in accordance with the systems and methods of the present disclosure may utilize any number of buffer regions that may be adapted to receive parcels from any number of inbound vision stations having any number of conveyors. Referring to FIGS. 4A, 4B and 4C, arrangements 400A, 400B, 400C of components of systems for automatically receiving inbound packages in accordance with embodiments of the present disclosure are shown. Except where otherwise noted, reference numerals preceded by the number “4” in FIG. 4A, 4B or 4C indicate components or features that are similar to components or features having reference numerals preceded by the number “3” shown in FIG. 3.

Referring to FIG. 4A, the arrangement 400A of components includes two conveyors 422A providing parcels 402A from an inbound vision station 420A, and two buffer regions 450A defined by two grids 452A for accommodating parcels 402A. Referring to FIG. 4B, the arrangement 400B of components includes two conveyors 422B providing parcels 402B from an inbound vision station 420B, and a single buffer region 450B defined by a single grid 452B for accommodating parcels 402B. Any combination of inbound vision stations, conveyors and/or buffer regions may be incorporated within warehouses or other storage facilities that operate in accordance with the systems and methods of the present disclosure. Accordingly, as is shown in FIG. 4A, parcels that are transported on either of the conveyors 422A to the buffer region 450A may be allocated to any of the subregions within either of the grids 452A. As is shown in FIG. 4B, parcels that are transported on either of the conveyors 422B to the buffer region 450B may be allocated to any of the subregions within the grid 452B.

Referring to FIG. 4C, the arrangement 400C of components includes a conveyor 422C providing parcels 402C from an inbound vision station 420C and a three-dimensional buffer region 450C defined by a three-dimensional grid or lattice 452C. As is shown in FIG. 4C, the buffer region 450C is adapted to accommodate parcels 402C in three dimensions, based on the respective levels of priority or relative rankings of the parcels and/or the items contained therein. Accordingly, parcels that are transported on the conveyor 422C to the buffer region 450C may be allocated to any of the subregions within the three-dimensional grid or lattice 452C.

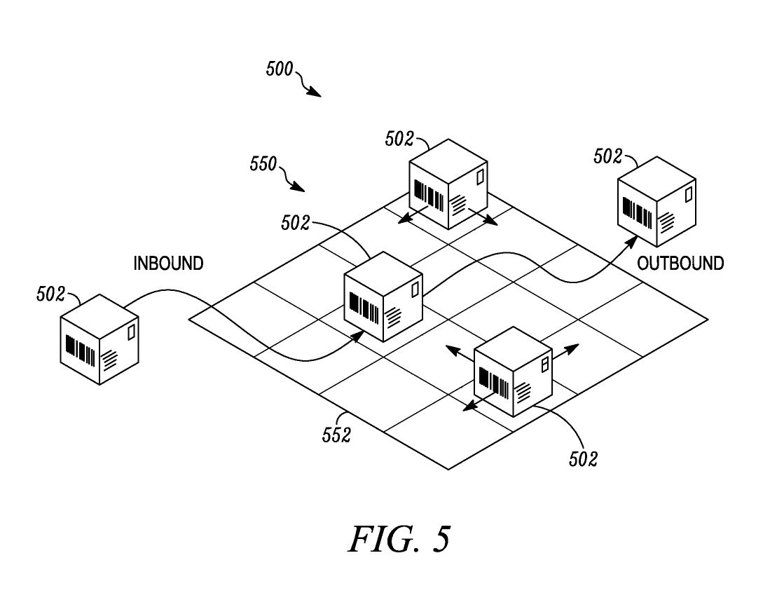

Additionally, parcels may be interchangeably positioned within a buffer region on any basis, in order to advance a parcel from an inbound video station through the buffer region for processing and transportation to an ultimate destination for preparation, storage or delivery. Referring to FIG. 5, an arrangement 500 of components of a system for automatically receiving inbound packages in accordance with one embodiment of the present disclosure is shown. Except where otherwise noted, reference numerals preceded by the number “5” in FIG. 5 indicate components or features that are similar to components or features having reference numerals preceded by the number “4” shown in FIG. 4A, 4B or 4C, or the number “3” shown in FIG. 3.

The arrangement 500 of components shown in FIG. 5 includes a buffer region 550 having various subregions defined by a four-by-four (4×4) grid 552. As is shown in FIG. 5, an inbound parcel 502 may be placed in or allocated to a subregion of the grid 552 along with other parcels 502, and transferred outbound from the buffer region 550 at a designated time. Alternatively, the locations of the parcels 502 may be rearranged or reshuffled within the buffer region 550 if the demands of the warehouse or other storage facility so require.

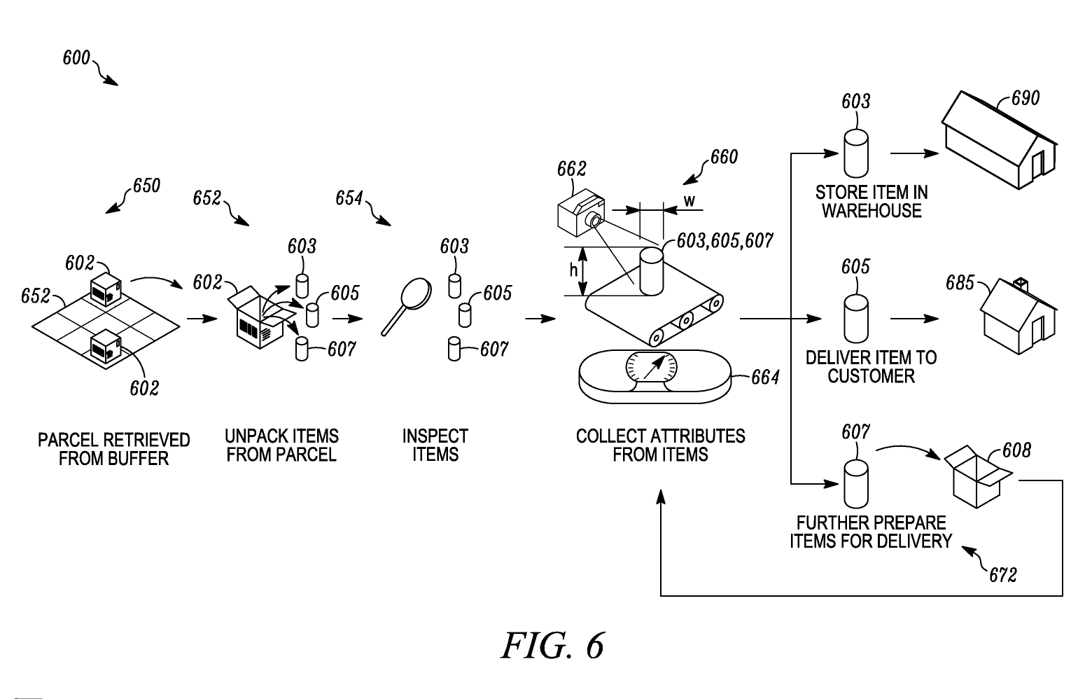

As is discussed above, where the processing of a parcel that is stored or maintained within a buffer region according to the systems and methods of the present disclosure is required, the parcel may be retrieved or extracted from the buffer, and the items therein may be singulated, so that one or more attributes or other information regarding the respective items may be gathered, and that the items may be transported to an ultimate destination for further processing, storage or delivery to customers. Referring to FIG. 6, a flow diagram 600 of a process for automatically receiving inbound packages in accordance with embodiments of the present disclosure is shown. Except where otherwise noted, reference numerals preceded by the number “6” in FIG. 6 indicate components or features that are similar to the steps of the flow chart 200 having reference numerals preceded by the number “2” shown in FIG. 2.

According to the flow diagram 600 of FIG. 6, at step 650, a parcel 602 may be retrieved from a buffer. At step 652, one or more items 603, 605, 607 contained therein may be unpacked and removed (i.e., singulated) from the parcel 602, and at step 654, the singulated items may be inspected for damage. Next, at step 660, the items may be placed on a conveyor and transported as one or more attributes (i.e., dimensions, masses or weights, images or other features) may be collected from each of the respective items. For example, the items may be photographed or scanned, such as by a camera 662 or other scanning or reading device, and weighed by a scale 664 or other like machine. Next, the items may be transported to their ultimate destination on the conveyor. For example, item 603 may be stored in a location within a warehouse or other facility, while item 605 may be delivered directly to a customer 685 who placed an order for the item. Item 607 may require further preparation, such as packaging into a new container 608 at step 672, and may return to step 665, where information or attributes may be gathered from the repackaged item, which may be placed in storage or delivered to a customer.

Accordingly, where one or more shipments and parcels has been received and placed in a prioritized position within a buffer region, the shipments or parcels may be recalled for processing upon request. In such a manner, the items therein may be unpacked from the shipments or parcels, and transported through one or more stations for automatically capturing or gathering information and other attributes therefrom, before being transported to a final destination for storage, delivery to customers or further preparation, in accordance with the systems and methods of the present disclosure. Moreover, as is discussed above, once a parcel has been retrieved and the items have been unpacked therefrom and inspected, the identities of such items may be confirmed and compared to any previously predicted identities of such items.

Although the disclosure has been described herein using exemplary techniques, components, and/or processes for implementing the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure. For example, although many of the embodiments described herein or shown in the accompanying figures include just one or more cameras, scanners or readers, any number of devices may be utilized to photograph, scan or interpret parcels or items, or any markings thereon, in accordance with the systems and methods of the present disclosure. Furthermore, although many of the embodiments described herein include conveyors that transport parcels or items in a fixed orientation through the stations described herein, such conveyors may be adapted to rotate the conveyors or items in transit to expose multiple faces of such items to any cameras, scanners or readers within such stations. Moreover, although the various stations of the receiving and registration systems disclosed herein are described as having discrete parts, the stations may be aggregated or combined with one another and mounted within a single tunnel-like apparatus or facility.

It should be understood that, unless otherwise explicitly or implicitly indicated herein, any of the features, characteristics, alternatives or modifications described regarding a particular embodiment herein may also be applied, used, or incorporated with any other embodiment described herein. Moreover, with respect to the one or more methods or processes of the present disclosure described herein, including but not limited to the flow chart shown in FIG. 2, or the arrangements of components shown in FIGS. 3-6, the order in which the steps of the methods or processes are listed is not intended to be construed as a limitation on the claimed inventions, and any number of the method or process steps can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described and illustrated with respect to exemplary embodiments thereof, the foregoing and various other additions and omissions may be made therein and thereto without departing from the spirit and scope of the present disclosure.

1. A method for registering a first parcel comprising:
identifying at least one of a source of the first parcel or an item contained in the first parcel, using at least one computer processor;
allocating the first parcel to a first storage area in a buffer region using at least one computer processor;
transporting the first parcel on at least one conveying device from a dock station to the first storage area;
determining a first priority level of one of the first parcel or the item using the at least one computer processor, wherein the first priority level is a ranking of the first parcel with respect to at least one other parcel in the buffer region;
transporting the first parcel on the at least one conveying device from the first predefined storage area in the buffer region to an unpacking station according to the first priority level;
unpacking the item from the first parcel at the unpacking station;
transporting the item on the at least one conveying device from the unpacking station to a destination station according to the first priority level; and
gathering at least one attribute of the item using the at least one computer processor as the item is transported on the at least one conveying device,
wherein the at least one attribute of the item comprises a weight of the item, a dimension of the item, an identifier of the item or a photograph of the item.

2. The method of claim 1, wherein the first parcel includes at least one bar code on at least one external surface of the first parcel,
wherein the first parcel is transported from the dock station to the first predefined storage area in view of at least one bar code scanner, and
wherein the step of identifying the at least one of the source of the first parcel or the item contained in the first parcel comprises:
scanning the at least one barcode with the at least one bar code scanner; and
identifying the source for the item based at least in part on the bar code using the at least one computer processor.

3. The method of claim 1, further comprising:
preparing the item for storage at the destination station; and
gathering at least one attribute for the prepared item, wherein the at least one attribute comprises a weight of the prepared item, a dimension of the prepared item, an identifier of the prepared item or a photograph of the prepared item.

4. The method of claim 1, wherein the step of determining the first priority level of the one of the first parcel or the item comprises:
determining an attribute of the first parcel, wherein the attribute of the first parcel is at least one of:
a time of arrival of the first parcel at the buffer region;
a time of departure of the first parcel from the buffer region;
an inventory level of the item;
an expiration date of the item;
a restriction on a sale of the item; or
a destination of the item;
determining an attribute of the at least one other parcel in the buffer region, wherein the attribute of the at least one other parcel is at least one of:
a time of arrival of the at least one other parcel at the buffer region;
a time of departure of the at least one other parcel from the buffer region;
an inventory level of an item contained in the at least one other parcel;
an expiration date of the item contained in the at least one other parcel;
a restriction on a sale of the item contained in the at least one other parcel; or
a destination of the item contained in the at least one other parcel; and
defining the first priority level based at least in part on a comparison of the attribute of the first parcel and the attribute of the at least one other parcel.

5. The method of claim 1, wherein the step of identifying the at least one of the source of the first parcel or the item continued in the first parcel comprises:
predicting an identity of the item according to a model using the at least one computer processor; and
wherein the method further comprises:
confirming the identity of the item based at least in part on the at least one attribute, using the at least one computer processor.

6. The method of claim 1, further comprising:
comparing the predicted identity of the item to the confirmed identity of the item, using the at least one computer processor; and
training the model based at least in part on the comparison of the predicted identity of the item to the confirmed identity of the item.

7. A system for receiving an inbound parcel comprising:
an area of a facility configured to receive the inbound parcel, the inbound parcel including an item contained therein, the area of the facility comprising:
an optical scanning device for reading an external marking on the inbound parcel;
a buffer region comprising a plurality of subregions, wherein at least one of the plurality of subregions is adapted to accommodate the inbound parcel;
at least one conveying device for transporting the inbound parcel from the at least one of the plurality of subregions to an unpacking station based at least in part on a first priority level;
the unpacking station adapted to remove the item from the inbound parcel; and
at least one computer for determining the first priority level.

8. The system of claim 7, further comprising:
a destination station, wherein the at least one conveying device is further adapted to transport the item from the unpacking station to the destination station.

9. The system of claim 8, wherein the first priority level is determined based at least in part on at least one of an inventory level of the item or a processing capacity at the destination station.

10. The system of claim 8, wherein the destination station comprises at least one storage location for the item.

11. The system of claim 8, wherein the destination station comprises at least one facility for causing a delivery of the item to a customer.

12. The system of claim 8, further comprising:
a detection device for determining at least one attribute of the item as the item is transported from the unpacking station to the destination station.

13. The system of claim 12, wherein the at least one attribute is one of a photograph of the item, a mass of the item or a dimension of the item.

14. The system of claim 12, wherein the at least one computer is adapted to determine an identity of the item based at least in part on the at least one attribute.

15. The system of claim 7, wherein the at least one computer is further adapted to interpret the external marking and identify at least one attribute of the item based at least in part on the external marking.

16. The system of claim 7, wherein the optical scanning device is adapted to capture a photograph of the external marking on the inbound parcel,
wherein the at least one computer is adapted to transmit the photograph of the external marking to an analysis station;
wherein the at least one computer is adapted to receive an interpretation of the external marking from the analysis station; and
wherein the at least one computer is adapted to identify a source of the inbound parcel or the item within the inbound parcel based at least in part on the interpretation of the external marking.

17. The system of claim 7, wherein the at least one computer is adapted to assign the inbound parcel to a first one of the plurality of subregions.

18. The system of claim 17, wherein the at least one computer is further adapted to assign a subsequent parcel to the first one of the plurality of subregions based at least in part on a second priority level,
wherein the at least one computer is adapted to assign the inbound parcel to a second one of the plurality of subregions; and
wherein the second priority level exceeds the first priority level.

19. The system of claim 7, wherein the plurality of subregions is defined by a two-dimensional grid.

20. The system of claim 7, wherein the plurality of subregions is defined by a three-dimensional lattice.

21. The system of claim 7, wherein the at least one computer is adapted to execute a program causing the at least one computer to determine the first priority level according to a method comprising:
identifying an attribute of the item contained in the inbound parcel based at least in part on the external marking;
identifying an attribute of each of a plurality of items in the buffer region; and
defining the first priority level based at least in part on a comparison of the attribute of the item contained in the inbound parcel to the attribute of at least one of the plurality of items in the buffer region.

22. The system of claim 21, wherein the attribute of the item contained in the inbound parcel is at least one of:
a time of arrival of the item contained in the inbound parcel at the buffer region;
a time of departure of the item contained in the inbound parcel from the buffer region;
an inventory level of the item contained in the inbound parcel;
an expiration date of the item contained in the inbound parcel;
a restriction on a sale of the item contained in the inbound parcel; or
a destination of the item contained in the inbound parcel.

23. A non-transitory computer readable medium having computer-executable instructions stored thereon,
wherein the instructions, when executed, cause a computer system connected to a network and having at least one computer processor to:
receive, over the network, information regarding an arrival of a first parcel at a loading station, wherein the first parcel includes at least one first item;
assign, using the at least one computer processor, the first parcel to a first subregion of a multi-dimensional buffer region;
cause the first parcel to be transported from the loading station through an inbound vision station to the first subregion via at least one conveying system, wherein the inbound vision station comprises at least one bar code reader and at least one optical character recognition device;
determine, using the at least one computer processor, a first priority level of the first parcel;
cause the first parcel to be transported from the first subregion to an unpacking station via the at least one conveying system based at least in part on the first priority level;
cause the at least one first item to be unpacked from the first parcel at the unpacking station; and
cause the at least one first item to be transported from the unpacking station to a destination via the at least one conveying system.

24. The non-transitory computer-readable medium of claim 23, wherein the destination is at least one of a storage location for the at least one item, a delivery station for delivering the at least one item to a customer and an item preparation station.

25. The non-transitory computer-readable medium of claim 23, wherein the at least one first item is transported from the unpacking station to the destination through an attribute gathering station, and
wherein the instructions, when executed, further cause the computer system to:
gather, using the at least one computer processor, an attribute of the at least one first item while the at least one first item is transported through the attribute gathering station.

26. The non-transitory computer-readable medium of claim 25, wherein the computer system is adapted to control at least one of the inbound vision station, the at least one conveying system or the attribute gathering station.

27. The non-transitory computer-readable medium of claim 26, wherein the loading station is adapted to receive parcels having at least two faces, and
wherein the inbound vision station comprises one bar code reader device and one optical character recognition device for each of the at least two faces.

28. The non-transitory computer-readable medium of claim 23, wherein the inbound vision station comprises a tunnel structure having the at least one bar code reader device and the at least one optical character recognition device mounted therein, and
wherein the at least one conveying system is adapted to transport the parcel from the loading station to the first subregion of the multi-dimensional buffer region through the tunnel structure.

29. The non-transitory computer-readable medium of claim 23, wherein the instructions, when executed, further cause the computer system to:
receive, over the network, an order for the at least one first item from a customer; and
cause a delivery of the at least one first item from the destination to the customer.

30. The non-transitory computer-readable medium of claim 23, wherein the instructions, when executed, further cause the computer system to:
predict, using the at least one computer processor, an identity of the at least one first item according to a model based at least in part on the information regarding the arrival of the first parcel at the loading station;
confirm, using the at least one computer processor, an identity of the at least one first item when the at least one first item is unpacked from the first parcel; and
train, using the at least one computer processor, the model based at least in part on the confirmed identity of the at least one item.
